(19) United States
(12) Patent Application Publication
(10) Pub. No.: US 2024/0221964 A1
(43) Pub. Date: Jul. 4, 2024

(54) REACTOR CAPABLE OF COPING WITH CORE MELTDOWN ACCIDENT WITH AIM OF PREVENTING RELEASE OF RADIOACTIVE SUBSTANCES

(71) Applicant: Tsuyoshi MATSUOKA, Hyogo (JP)

(72) Inventor: Tsuyoshi MATSUOKA, Hyogo (JP)

(21) Appl. No.: 17/998,988

(22) PCT Filed: Sep. 25, 2021
(86) PCT No.: PCT/JP2021/035210

§ 371 Date: Mar. 30, 2023

(51) Int. Cl. G21C 15/18; G21C 9/008

(52) U.S. Cl. CPC G21C 15/18; G21C 9/008

(57) ABSTRACT

[Objective] An object is to provide a reactor which can cope with a core meltdown accident; i.e., can keep the soundness of a reactor pressure vessel and a reactor containment vessel and prevent release of radioactive substances to the outside even when a core meltdown accident occurs.

[Means for solution] A reactor 1 includes water-injection-to-core interruption means, provided for a possible core meltdown accident, for stopping injection of water into a core after occurrence of a zirconium-water reaction or film boiling in the core is detected on the basis of core pressure or the like. In order to remove core decay heat by natural cooling or water-cooling of the outer surface of a reactor pressure vessel 3 or the outer surface of a heat insulation 4 after injection of water into the core is stopped at the time of a core meltdown accident, the reactor 1 includes melting point restriction management means for managing a melting point restriction in material selection at the time of manufacture of the heat insulation 4 so that the heat insulation 4 melts and breaks without fail at the time of the core meltdown accident, or water injection means for injecting water into the space between the heat insulation 4 and a shield concrete 13.

### FIELD OF THE INVENTION

The present invention relates to a reactor capable of coping with a core meltdown accident with an aim of preventing release of radioactive substances. In particular, the present invention relates to a reactor which is used in a boiling water reactor (hereinafter may be abbreviated as “BWR” in some cases) or a pressurized water reactor (hereinafter may be abbreviated as “PWR” in some cases) and which can cope with a severe accident of core meltdown by safely bringing the reactor into a stable state, keeping the soundness of the reactor pressure vessel and the reactor containment vessel (hereinafter, these may be referred simply as “pressure vessel” and “containment vessel,” respectively, in some cases), and preventing release of radioactive substances to the outside.

For achieving the aim, the present invention proposes a new cooling method for cooling a reactor at the time of a severe accident of core meltdown (a natural cooling method or a water cooling method in which cooling is performed through the outer surface of the reactor pressure vessel or the outer surface of its heat insulator (hereinafter referred to as “heat insulation” or “insulation”)), as well as a new pressure releasing (pressure reducing) means and a radioactive substance purifying (removing) means, which are provided at a pressure boundary of the reactor containment vessel.

These proposals are based on the results of analysis and evaluation, performed by the present inventor, of data collected at the time of the accident at the Fukushima Daiichi Nuclear Power Plant of the Tokyo Electric Power Company (hereinafter referred to as the “TEPCO Fukushima accident”), which occurred on Mar. 11, 2011.

In consideration of such a possible severe accident, a first reactor of the present invention includes the means (1) described in (1) of claim 1 of the CLAIMS, which will be described later (hereinafter may be referred to simply as “claim 1”, “the means (1) of claim 1”; the same applies to other claims, means in some cases). This first reactor is preferably used as a boiling water reactor (BWR).

Also, in consideration of such a possible severe accident, a second reactor of the present invention includes the means (1) to (3) described in (1) to (3) of claim 2 of the CLAIMS. This second reactor is preferably used as a pressurized water reactor (PWR).

Notably, in the boiling water reactor (BWR), a top lid of its containment vessel is fixed with bolts, and abundant water is present inside a pressure suppression chamber (suppression chamber). Therefore, the means (2) and (3) are unnecessary.

### BACKGROUND OF THE INVENTION

Conventionally, in the case of a BWR and in the case of a PWR, in order to cope with a severe accident such as an core meltdown accident as described in (1)(a) of claim 1 and claim 2, water is actively injected into the core because water injection into the core is not prohibited.

Also, as to the melting point restriction on the material used for the heat insulation of the reactor pressure vessel as described in (1)(b) (for the case (i)) of claim 1 and claim 2, the material of the heat insulation (in general, a metal heat insulation) is chosen such that the heat insulation does not melt at the designed temperature (highest operating temperature). However, conventionally, no regulation demands that, after water injection into the core is stopped at the time of a core meltdown accident, the heat insulation around a high-temperature heated portion of the reactor pressure vessel melts and breaks without fail.

Also, as to the means (1)(b) (for the case (ii)) described in (1)(b) (for the case (ii)) of claim 1 and claim 2, conventionally, there has not been performed a water cooling method after stoppage of water injection into the core, which is the method for injecting the cooling water into the space inside the shield concrete, which constitutes the shield wall of the reactor pressure vessel, between the heat insulation of the reactor pressure vessel and the shield concrete, thereby water-cooling the outer surface of the reactor pressure vessel or the outer surface of its heat insulation.

Furthermore, as to the large-diameter through hole formed at the pressure boundary of the reactor containment vessel as described in (2) and (3) of claim 2, in the case of the conventional PWR, as shown in FIG. 2, transportation pipe 10′ (fuel transportation apparatus having rails laid therein), which is horizontally disposed in a penetration portion for fuel transportation 12 of the containment vessel 6, corresponds to the large-diameter through hole. However, as described in FIG. 2, conventionally, after the lid of the fuel transportation pipe 10′ is removed temporarily, the pipe is submerged in water only at the time of fuel exchange (refueling), and water is drained after completion of fuel exchange. During operation, the empty state (in which water has been drained) is maintained, and a lid is attached to the fuel transportation pipe 10′.

Accordingly, there is a possibility that, at the time of a severe accident in which the core melts, the pressure within the containment vessel 6 increases abnormally, and the containment vessel 6 is pressurized excessively, whereby the containment vessel 6 ruptures, and a large amount of a radioactive substance is released from the ruptured portion of the containment vessel 6 to the outside without being purified or removed by water.

### SUMMARY OF THE INVENTION

### Problem to be Solved by the Invention

The present invention has been accomplished so as to solve the problems of conventional reactors as described above. In particular, the present invention has been accomplished by investigating the cause of the TEPCO Fukushima accident that occurred in 2011 and utilizing the lessons learned from the accident. An object of the present invention is to provide a reactor which can cope with a core meltdown accident; specifically, can keep the soundness of the reactor pressure vessel and the reactor containment vessel and prevent (minimize) release of radioactive substances to the outside even when a core meltdown accident occurs.

### Means for Solving the Problem

The problems as described above are solved by the following inventions described in claims of the CLAIMS of the present application.

Namely, the invention described in claim 1 thereof is a reactor which can cope with a core meltdown accident with an aim of preventing release of radioactive substances, the reactor being characterized by comprising the following means (1) whereby, at the time of a possible core meltdown accident, the reactor is naturally cooled or water-cooled through an outer surface of a reactor pressure vessel or an outer surface of its heat insulation and release of radioactive substances is prevented:
(1)(a) water-injection-to-core interruption means, provided for a possible core meltdown accident, for stopping injection of water into a core after occurrence of a zirconium-water reaction or film boiling in the core is detected on the basis of core pressure or the like, and
(b) means for naturally cooling or water-cooling the outer surface of the reactor pressure vessel or the outer surface of the heat insulation, whereby, when a core meltdown accident occurs, after injection of water into the core is stopped by the water-injection-to-core interruption means (a), core decay heat is removed not only by radiation of radiant heat from the outer surface of the reactor pressure vessel but also removed as a result of natural cooling or water cooling of the outer surface of the reactor pressure vessel or the outer surface of the heat insulation, wherein
in the case (i) where the reactor is small in size, the means for natural cooling or water cooling is melting point restriction management means for the heat insulation which manages a melting point restriction in material selection at the time of manufacture of the heat insulation so that the heat insulation melts and breaks without fail at the time of the core meltdown accident, whereby the core decay heat is removed also by natural cooling of the outer surface of the reactor pressure vessel, and
in the case (ii) where the reactor is large in size, the means for natural cooling or water cooling is water injection means for injecting water into a space between the heat insulation of the reactor pressure vessel and a shield concrete, whereby the core decay heat is removed also by water cooling of the outer surface of the reactor pressure vessel or the outer surface of the heat insulation.

Also, the invention described in claim 2 thereof is a reactor which can cope with a core meltdown accident with an aim of preventing release of radioactive substances, the reactor being characterized by comprising the following means (1) to (3) whereby, at the time of a possible core meltdown accident, the reactor is naturally cooled or water-cooled through an outer surface of a reactor pressure vessel or an outer surface of its heat insulation and release of radioactive substances is prevented.
(1)(a) Water-injection-to-core interruption means, provided for a possible core meltdown accident, for stopping injection of water into a core after occurrence of a zirconium-water reaction or film boiling in the core is detected on the basis of core pressure or the like, and
(b) means for naturally cooling or water-cooling the outer surface of the reactor pressure vessel or the outer surface of the heat insulation, whereby, when a core meltdown accident occurs, after injection of water into the core is stopped by the water-injection-to-core interruption means (a), core decay heat is removed not only by radiation of radiant heat from the outer surface of the reactor pressure vessel but also removed as a result of natural cooling or water cooling of the outer surface of the reactor pressure vessel or the outer surface of the heat insulation, wherein
in the case (i) where the reactor is small in size, the means for natural cooling or water cooling is melting point restriction management means for the heat insulation which manages a melting point restriction in material selection at the time of manufacture of the heat insulation so that the heat insulation melts and breaks without fail at the time of the core meltdown accident, whereby the core decay heat is removed also by natural cooling of the outer surface of the reactor pressure vessel, and
in the case (ii) where the reactor is large in size, the means for natural cooling or water cooling is water injection means for injecting water into a space between the heat insulation of the reactor pressure vessel and a shield concrete, whereby the core decay heat is removed also by water cooling of the outer surface of the reactor pressure vessel or the outer surface of the heat insulation;
(2) a large-diameter through hole provided at a pressure boundary of a reactor containment vessel and a rupture plate provided in the through hole; and
(3) means for submerging the through hole of the means (2) in water during ordinary operation of the reactor.

Next, the process through which the present inventor has reached completion of these inventions will be described in further detail.

The present inventor analyzed by himself the cause of the core meltdown accident in the TEPCO Fukushima accident. The result of the analysis revealed that expansion of the core meltdown accident occurred because water injection into the core was continued despite a film boiling phenomenon having already occurred in the core.

Also, although there was a possibility that the reactor containment vessel also ruptures, the result of the analysis shows that, in the BWR, since the top lid of its containment vessel is fixed with bolts, the lid luckily lifted to thereby suppress a pressure increase, and consequently, rupture was avoided.

As to the cause of expansion of the core meltdown accident, how the inventor reached the above-described analysis results will be described in further detail on the basis of the results of chronological analysis and evaluation of data collected at the time of the accident.

The inventor analyzed and evaluated by himself data collected in a period of the first 14 hours after occurrence of the accident at Unit 1 of the Fukushima Daiichi Nuclear Power Plant of the Tokyo Electric Power Company (hereinafter may be referred to as the “Fukushima Unit 1” in some cases). Unit 1 is a boiling water rector (BWR). From the results of the analysis and evaluation of the data (attached Material 1, pages 3 to 7), it was found that, although the core had already melted, the reactor pressure vessel was sound, and the outer surface of the pressure vessel (a high temperature portion around the molten core) was naturally cooled. It is considered that such natural cooling of the outer surface of the pressure vessel occurred because the heat insulation melted and broke before the pressure vessel ruptures.

The reasons why the reactor pressure vessel was sound despite the core having already melted are as follows:
the outer surface of the pressure vessel was naturally cooled as described above; and
injection of water into the core by a fire pump or the like was not performed until first 14 hours had elapsed after occurrence of the accident.

The accident expanded because water was injected into the core by a fire pump after that (after elapse of 14 hours). Namely, conceivably, the water injection promoted a zirconium-water reaction (exothermic reaction), thereby causing hydrogen explosion, penetration of the bottom of the reactor pressure vessel, and release of a large amount of radioactive substances.

These conclusions were completely different from the conventional common knowledge. The present invention has been achieved by reflecting the lessons learned from the accident. The reactor of the invention includes “water-injection-to-core interruption means, provided for a possible core meltdown accident, for stopping injection of water into the core after occurrence of a zirconium-water reaction or film boiling in the core is detected on the basis of core pressure or the like” (the means (1) (a) of claim 1); and
“melting point restriction management means for the heat insulation which manages a melting point restriction in material selection at the time of manufacture of a heat insulation so that the heat insulation melts and breaks without fail at the time of the core meltdown accident, whereby, when the core meltdown accident occurs, after injection of water into the core is stopped, core decay heat is removed not only by radiation of radiant heat from the outer surface of the reactor pressure vessel but also by natural cooling of the outer surface of the reactor pressure vessel” (the means (1)(b) of claim 1 (for the case (i))).

Notably, in the case of a large reactor whose output is high (higher than 460,000 kw (the output of Fukushima Unit 1)), natural cooling of the outer surface of the reactor pressure vessel is insufficient for the demanded cooling. Therefore, water injection means for injecting water into the space inside the shield concrete (between the heat insulation of the reactor pressure vessel and the shield concrete) is provided, and, by means of heat of evaporation of the water, the outer surface of the reactor pressure vessel or the outer surface of its heat insulation is water-cooled (the means (1) (b) of claim 1 (for the case (ii)).

Incidentally, in the case of the PWR, its containment vessel has a welded structure and does not have a bolt-on structure, which is employed for the top lid of the containment vessel of the BWR. In the PWR, a facility similar to the pressure suppression chamber (suppression chamber: S/C) of the BWR is not present. Therefore, if an accident of all power loss like the TEPCO Fukushima accident occurs and water is continuously injected into the core by using a fire pump or the like, the internal pressure of the containment vessel becomes excessively high (overpressure), and the containment vessel may rupture. In addition, if the core reaches a film boiling state, the zirconium-water reaction is highly likely to be accelerated with the pressure added. Therefore, the pressure must be reduced quickly by using a large-diameter pressure reducing apparatus.

In view of the above, in the present invention, the fuel transportation pipe 10′, which has been conventionally disposed at the pressure boundary of the containment vessel and used at the time of fuel exchange, is used, as it is, as a large-diameter through hole 10 formed at the pressure boundary of the containment vessel, and a lid used for closing the fuel transportation pipe 10′ is replaced with a rupture plate (rupture disk), which is disposed in the through hole 10 (the means (2) of claim 2).

Also, after the rupture plate is broken, fission products (FPs), which are radioactive substances, are released from the broken portion. Therefore, it is necessary to reduce the release of FPs.

FPs include radioactive gases (rare gases) which are insoluble in water, and volatile FPs which easily dissolve in water. Since most radioactive gases (rare gases) are short-lived, they decay immediately and their radioactivity decreases. However, since volatile FPs are high in radioactivity level, it is necessary to cause the volatile FPs to pass through water, thereby reducing radioactivity.

In view of the above, in the present invention, a region around the through hole, including the rupture plate, is submerged in water at the time of ordinary operation of the reactor (the means (3) of claim 2).

The idea of changing the operation of the PWR in the above-described manner was conceived on the basis of the results of the present inventor's analysis and evaluation of data exhibited by Fukushima Unit 1 (BWR) in the TEPCO Fukushima accident (attached Material 2, 5(1) Fundamental approach, on pages 7 to 8).

Namely, in Fukushima Unit 1, although the containment vessel pressure increased abnormally as a result of an unexpected accident, rupture of the containment vessel was avoided. The reason for this is that, since the top lid of the containment vessel was fixed by bolts, the top lid lifted, and the generated gas (hydrogen and steam) leaked.

In addition, the level of released radioactivity was extremely low. The reason for this is that the leaked gas was a gas which had passed through abundant water within the pressure suppression chamber (suppression chamber: S/C) within the containment vessel. Namely, the greater part of radioactive substances was removed in water.

The means (2) and (3) of claim 2 show the feature of the PWR in which these results of the analysis and evaluation are reflected.

### Effects of the Invention

Since the present invention is configured as described above, the invention can achieve the following actions and effects.

### (Actions and Effects of the Invention of Claim 1)

First, the actions and effects of the invention described in claim 1 of the CLAIMS (hereinafter, referred to simply as “the invention of claim 1”. The same applies to other claims) will be described.

The invention of claim 1 includes means for reliably keeping a stable state even after elapse of 10 to 14 hours from occurrence of an accident, the stable state being a state which is observed after 10 to 14 hours from occurrence of an accident, like the all power loss accident of Fukushima Unit 1 (BWR), and in which the pressure of the reactor containment vessel is stable.

As described above, this means is composed of the following means (1); i.e., means (a) and (b):
(1)(a) water-injection-to-core interruption means, provided for a possible core meltdown accident, for stopping injection of water into a core after occurrence of a zirconium-water reaction or film boiling in the core is detected on the basis of core pressure or the like, and
(b) means for naturally cooling or water-cooling the outer surface of the reactor pressure vessel or the outer surface of the heat insulation, whereby, when a core meltdown accident occurs, after injection of water into the core is stopped by the water-injection-to-core interruption means (a), core decay heat is removed not only by radiation of radiant heat from the outer surface of the reactor pressure vessel but also removed as a result of natural cooling or water cooling of the outer surface of the reactor pressure vessel or the outer surface of the heat insulation, wherein, in the case (i) where the reactor is small in size, the means for natural cooling or water cooling is melting point restriction management means for managing a melting point restriction in material selection at the time of manufacture of the heat insulation so that the heat insulation melts and breaks without fail at the time of the core meltdown accident, whereby the core decay heat is removed also by natural cooling of the outer surface of the reactor pressure vessel, and, in the case (ii) where the reactor is large in size, the means for natural cooling or water cooling is water injection means for injecting water into a space between the heat insulation of the reactor pressure vessel and a shield concrete, whereby the core decay heat is removed also by water cooling of the outer surface of the reactor pressure vessel or the outer surface of the heat insulation.

The actions and effects of the above-described means are as follows.

First, the action and effect of the means (1)(a) will be described.

In a state in which measuring instruments cannot be used because of, for example, all (AC and DC) power loss as in the TEPCO Fukushima accident, when unexpected stoppage of a permanent core cooling facility, insufficiency of cooling water, or the like is found, water injection into the core by using fire pump or the like is continued. Meanwhile, core exposure and fuel temperature are predicted on the basis of core decay heat (this is calculated from the time elapsed after stoppage of the reactor) and the time elapsed after stoppage of the facility, occurrence of cooling water shortage, or the like, and the possibility of occurrence of a zirconium-water reaction or film boiling is calculated. When the possibility exists, the water injection into the core is stopped immediately (the means (1)(a) of claim 1).

In the accident at Fukushima Unit 1, after elapse of 14 hours from occurrence of the accident, water was injected into the core by using a fire pump. Therefore, a zirconium-water reaction occurred in the core, and a large amount of hydrogen and a large amount of steam were released, which caused hydrogen explosion. Therefore, if there is a possibility that the zirconium-water reaction occurs in the core or the boiling state changes to film boiling, it is desired to take the above-described measure first.

When the above-described measure are taken, it is possible to avoid hydrogen explosion and keep, without fail, the state in which the pressure of the reactor containment vessel is stable.

Next, the action and effect of the means (1)(b) for the case (i) will be described.

After the water injection into the core is stopped as described above, due to decay heat of fuel, radiant heat from the fuel having a high temperature higher than 1000° C. becomes dominant within the core. Within the core, the fuel and a part or the greater part of the fuel cladding formed of zircaloy melt, stainless structure members or the like near the molten core also melt, and the temperature of the wall of the reactor pressure vessel starts to increase.

In the case of Fukushima Unit 1, the heat insulation of the reactor pressure vessel is formed of aluminum, and its melting point is about 650° C. Therefore, when the temperature of the wall surface of the pressure vessel (in particular, a high temperature portion around the molten core) becomes about 650° C., the heat insulation therearound melts and breaks.

After that, presumably, the wall of the pressure vessel is cooled as a result of radiation of radiant heat generated by the pressure vessel itself and radiation of heat via heat transmission by natural convection of gas (steam and nitrogen gas charged into the containment vessel from the beginning) around the pressure vessel, and the soundness of the reactor pressure vessel is maintained.

Accordingly, at the time of the core meltdown accident, in order to remove core decay heat after stoppage of water injection into the core, it is extremely effective to remove the core decay heat not only by radiation of radiant heat from the wall of the pressure vessel but also by natural cooling of the outer surface of a wall portion of the pressure vessel, which portion is located near the molten core and has a high temperature, in the case where the reactor is a small (whose output is 460,000 kw) like Fukushima Unit 1. Therefore, in order to melt and break the heat insulation without fail, during manufacture of the heat insulation, the melting point of the selected material is restricted and managed such that the melting point becomes a temperature suitable for melting and breaking the heat insulation. Namely, the melting point restriction in material selection at the time of manufacture of the heat insulation is managed (the means (1)(b) of claim 1 for the case (i)).

By virtue of the above, the heat insulation has a sufficient margin under the design conditions. However, after stoppage of water injection into the core at the time of the core meltdown accident, the temperature of the heat insulation reaches its melting point before the strength in high temperature of the reactor pressure vessel drops considerably and its function deteriorates sharply. As a result, the heat insulation, including its fixture portions, can be melted or broken without fail. Namely, a desired heat insulation can be selected.

As a result, the reactor pressure vessel is cooled by radiation of its radiant heat and is also naturally cooled by gas flow therearound. Since the zirconium-water reaction has been stopped, the interior of the reactor pressure vessel is cooled gradually as the decay heat decreases, and the internal state changes safely to a stable state (converged state), whereby the soundness of the reactor pressure vessel can be maintained.

Since the material of the present reactor pressure vessel is low-alloy steel, its strength in high temperature decreases considerably at 600 to 700° C. Since the melting point of an aluminum heat insulation commonly used at the present is about 650° C., the above-described melting point condition demanded for the heat insulation is satisfied.

Next, the action and effect of the means (1)(b) for the case (ii) will be described.

In the case of a large reactor whose output is high (higher than 460,000 kw (the output of Fukushima Unit 1)), natural cooling of the outer surface of the reactor pressure vessel is insufficient for the demanded cooling. Therefore, water injection means for injecting water into the space between the heat insulation of the reactor pressure vessel and the shield concrete (the space inside the shield concrete) after interruption of water injection into the core is provided (the means (1)(b) of claim 1 for the case (ii)), and, by means of heat of evaporation of the water, the outer surface of the reactor pressure vessel or the outer surface of the heat insulation is water-cooled.

By virtue of this, in addition to the cooling by radiation of radiant heat from the outer surface of the reactor pressure vessel, a sufficient degree of cooling can be achieved so as to remove the core decay heat. In this case, the heat insulation may be broken as a result of melting or may not be broken (cooling is possible). However, in the case where the heat insulation is broken as a result of melting, an effect of increasing the cooling speed can be yielded.

(Approximate Calculation of the Amount of Heat Radiated from the Outer Surface of the Pressure Vessel as a Result of Natural Cooling)

The amount of heat radiated from the outer surface of the pressure vessel, as a result of natural cooling, in a state in which the heat insulation is broken is approximately calculated for Fukushima Unit 1. Although the description will become somewhat long, this approximate calculation will be described with reference to FIGS. 3 and 4. Please refer to Material 1 for more detailed description.

In Fukushima Unit 1, the reactor was isolated immediately after the accident. Therefore, no water was injected into the core, and water inside the reactor disappeared due to the decay heat of fuel (after 20:00 on 3/11 (this means March 11; hereinafter, this rule applies)), the core melted, and radiant heat became predominant.

In this state, the pressure of the reactor containment vessel was kept at 0.6 MPa from 23:50 on 3/11 to 01:05 on 3/12 but then it rose suddenly to 0.84 MPa at 02:30.

Conceivably, this phenomenon occurred because the wall surface temperature of a portion of the rector pressure vessel 3 nearest to the melted core rose to approximately 650° C. (the melting point of the aluminum heat insulation), and the heat insulation 4 therearound melted and broke. As a result, that wall surface was cooled, and the temperature increase was suppressed. However, the pressure in the drywell (hereinafter referred to as “D/W”) 14 of the reactor containment vessel 6 rose suddenly due to heat input from that wall surface.

The state in the D/W 14 prior to the insulation breakage is the saturated state of 0.6 MPa (T₀=159° C.). After breakage of the heat insulation, the temperature of the D/W 14 side of an insulation broken portion 18 at a lower portion of a region inside the shield wall 13 rises, and a high temperature superheated steam 19 flows upward to the space of a D/W upper portion 14a. The D/W 14 is structured such that the high temperature superheated steam (the average temperature is T₁° C.) accumulates in the space of the D/W upper portion 14a. After the high-temperature superheated steam has accumulated there, a high temperature part keeping thermal stratification flows downward to a mixing region 20 where the high temperature upward steam 19 and low temperature steam of T₀° C. are mixed (the average temperature of the superheated steam in the mixture is represented by T₂° C.). In an upper portion of the mixing region 20, a temperature stratification region 21 including a layer of T₁° C. and a layer of T₂° C. is formed. Meanwhile, in an intermediate and a lower portion of the mixing region 20, the superheated steam (the average temperature is T₂° C.) mixed with the low temperature steam gradually expands and descends from the space on the outside of the shield wall 13 toward a D/W lower portion 14b, while keeping thermal stratification (T₂−T₀) at its lower area.

Meanwhile, the flow around the broken portion 18 must be considered three-dimensionally, because the lower end of the space on the inner side of the shield wall 13 is closed by a skirt portion 22 of the reactor pressure vessel. Namely, in the space located around the broken portion 18 and on the inner side of the shield wall 13, in order to replenish steam for forming the upward flow 19 of the high temperature superheated steam from the broken portion 18, the low temperature steam around the shield wall 13 forms a downward flow which reaches the broken portion 18 while detouring around the upward flow 19. Specifically, the low temperature steam in the D/W lower portion 14b ascends on the outer side of the shield wall 13, turns at the lower area of the mixing region 20 at the top of the shield wall 13, and descends toward the broken portion 18. In this manner, a flow of low temperature steam is formed so as to replenish steam for forming the upward flow 19 of the high temperature steam.

However, in a region other than the region where the low temperature steam descends, as described above, the temperature region of a constant temperature T₂° C. formed as a result of the high temperature upward flow 19 and the low temperature steam mixing together in the mixing region 20 descends gradually on the outer side of the shield wall 13, while keeping thermal stratification (T₂−T₀) at its lower area, and expands over the entire space of the D/W lower portion 14b. During that time, the pressure inside the D/W 14 increases continuously due to thermal expansion caused by heat from the broken portion 18 (the amount of input heat is q kW). The reason why the high temperature region is assumed to expand while keeping thermal stratification is that, as compared with the amount of heat radiated from the outer surface of the D/W 14, the amount of heat (q kW) inputted from the heat insulation broken portion 18 is very large, and conceivably, a phenomenon in which thermal stratification occurs due to a difference in density is predominant over a phenomenon in which the entire steam circulates due to convection.

When the superheated steam in the T₂° C. area fills the entire space of the D/W lower portion 14b, the interior of the D/W 14 is divided to two temperature areas; i.e., the T₁° C. area in the space of the upper portion 14a and the T₂° C. area in the space of the lower portion 14b. After that, conceivably, the internal pressure increases in a stable mixed state (including a flow caused by the high temperature upward flow 19). When the region of thermal stratification (T₂−T₀) descends, no evaporation occurs in the area of T₀° C. (the saturated temperature), but evaporation occurs in the area of T₂° C. (the temperature of the superheated steam); i.e., many condensed water droplets or the like present on the surfaces of machines and facilities within the D/W 14 start to evaporate.

Here, the whole volume of the D/W 14 is defined as V₀ m³ (=3400 m³) and is divided into two parts: the volume V₁ m³ of the space of the upper portion 14a and the volume V₂ m³ of the space of the lower portion 14b in such a manner that V₁=0.05 V₀ and V₂=0.95 V₀, where V₀=V₁+V₂. For simplification of calculation, the progress is divided into two stages: a first stage from breakage of the insulation to the start of leakage and a second stage from the start of leakage to generation of peak pressure. Each stage is considered, with elapsed time being represented by t (unit: second).

During the first stage, the interior of the D/W 14 is divided into the T₁° C. area of the upper portion 14a and the T₂° C. area of the lower portion 14b. In the lower portion 14b, the T₀° C. area where no evaporation occurs shrinks, and the T₂° C. area where evaporation occurs expands. This continues until the leakage starts (the D/W top lid 6a lifts). Meanwhile, in the second stage, the T₂° C. area covers the entirety of the lower portion 14b and stable evaporation occurs. This state continues until the peak pressure of 0.84 MPa is reached.

The reason why two stages are considered separately is as follows: some margin is provided for the pressure and temperature since the pressure and temperature at the leakage start point are estimated values, and estimation of input heat q kW is facilitated by setting the release mass flow (leakage amount) x=0. As to the amount q (KW) of heat inputted from the broken portion 18, the same value is used for both stages. The amount of evaporation in the D/W 14 is represented by u (kg/s). The evaporation amount in the first stage is represented by u1, and the evaporation amount in the second stage is represented by u2. The release mass flow after lifting of the top lid 6a is represented by x (kg/s). Notably, u and x are mean values. Although their enthalpy must be represented by the average of the value before the evaporation or the release and the value after the evaporation or the release, their enthalpy difference is small when the temperature is constant. Therefore, they are represented by values after t seconds.

First, the first stage from the insulation breakage to the start of leakage will be studied.

A state before the insulation breakage (initial state) is a saturated state of 0.6 Mpa (T₀=159° C.), in which the specific volume v″ is 0.316 m³/kg, the steam enthalpy h″ is 2756 KJ/kg, and the water enthalpy h′ is 670 KJ/kg. It is considered that, at a pressure near 0.76 Mpa, the D/W top lid 6a lifted and leakage occurred. Here, it is assumed that the upper portion of the interior of the D/W 14 became the state of the T₁° C. area, and the lower portion became the state of the T₂° C. area, and T₁ is determined to be 400° C. as measured at 03:21 on 3/12. T₂ is determined to be 200° C. which is a temperature at which the evaporation amount u1 became nearly zero at a pressure near 0.76 MPa. At the leakage start point, the D/W upper portion 14a (whose volume is V₁ m³) is filled with superheated steam of 400° ° C. and 0.76 MPa, where its specific volume v₁ is 0.457 m³/kg and its enthalpy h₁ is 3269 KJ/kg. The D/W lower portion 14b (whose volume is V₂ m³) is filled with superheated steam of 200° ° C. and 0.76 MPa, where its specific volume v₂ is 0.312 m³/kg and its enthalpy h₂ is 2840 KJ/kg. The formulas for conservation of mass and energy during the first stage are given below,

$${V}_{0} / {v}^{″} + {u}_{1} t = {V}_{1} / {v}_{1} + {V}_{2} / {v}_{2} \qquad ( 1 )$$

$${V}_{0} / {v}^{″} \times {h}^{″} + qt - {u}_{1} t ( {h}_{2} - {h}^{′} ) = {V}_{1} / {v}_{1} \times {h}_{1} + {V}_{2} / {v}_{2} \times {h}_{2} \qquad ( 2 )$$

When the above numerical values are put into formula (1), u₁ becomes just zero (u₁=0). So, by putting the value of u₁ into formula (2) and rearranging it, qt=960×10³ (kJ) is obtained. This qt (kJ) is equivalent to 1400 kW×690 s or 1600 kW×600 s, and these values are used for selection of q kW in the second stage.

Next, the second stage up to the point of the peak pressure is studied.

The formulas of conservation of mass and energy for the case where the state changes from the state (state 1) at the leakage start point to the state (state 2) at the point of the peak pressure 0.84 MPa are expressed by the following formulas (3) and (4), respectively, wherein ( )₁ is used for state 1, and ( )₂ is used for state 2.

$${( {V}_{1} / {v}_{1} + {V}_{2} / {v}_{2} )}_{1} + {u}_{2} t = {( {V}_{1} / {v}_{1} + {V}_{2} / {v}_{2} )}_{2} + xt \qquad ( 3 )$$

$${( {V}_{1} / {v}_{1} \times {h}_{1} + {V}_{2} / {v}_{2} \times {h}_{2} )}_{1} + qt - {u}_{2} t ( {h}_{2} - {h}^{′} ) = {( {V}_{1} / {v}_{1} \times {h}_{1} + {V}_{2} / {v}_{2} \times {h}_{2} )}_{2} + {xth}_{1} \qquad ( 4 )$$

The values of the state 1 are the same as previously described, but the values of the state 2 are determined from the following conditions. The D/W upper portion 14a is filled with superheated steam of 400° C. and 0.84 MPa, where its specific volume v₁ is 0.419 m³/kg and its enthalpy h₁ is 3268 KJ/kg. The D/W lower portion 14b is filled with superheated steam of 200° C. and 0.84 MPa, where its specific volume v₂ is 0.286 m³/kg and its enthalpy h₂ is 2837 KJ/kg. By putting the numerical values into formula (3) and arranging it, u₂t=950+xt is obtained. By putting it into formula (4), qt=580×10⁴+5440xt is obtained.

Here, corresponding to the measured values, it is presumed that the heat insulation 4 broke at about 01:00 on 3/12 when 0.6 MPa was measured, the D/W pressure reached 0.84 MPa at about 02:30, and leakage started in the middle at 0.76 MPa. The input heat q kW is calculated under this presumption.

At first, qt1=1400 kW×690 s and 1600 kW×600 s are selected as candidates from the first stage. Since the measured data shows that the peak pressure was reached when about 90 minutes elapsed after the breakage of the heat insulation, the release mass flow (x) is calculated by inputting these two values into the calculated result of the second stage. Consequently, for 1400 kW, x=0.03 kg/s (xt=140 kg) is obtained, and for 1600 kW, x=0.07 kg/s (xt=350 kg) is obtained. Considering a decrease in the pressure of the reactor containment vessel starting at about 03:00, cooling and pressure reduction may be caused by condensation and evaporation of the released steam. So, the inventor considers that the latter candidate (the amount of release mass xt is large) is adequate, and selects q=1600 kW.

The above results show the following. The heat insulation 4 melted and broke at about 01:00 on 3/12, and heat (about 1600 kw) was inputted from the wall of the reactor pressure vessel to the interior of the containment vessel 6, so that the containment vessel pressure rose suddenly. Then 10 minutes later, the top lid 6a lifted and leakage started. The containment vessel pressure reached 0.84 MPa at about 02:30 (90 minutes later). These calculated data explain well changes in the actually measured values.

In the above, approximate calculation for radiation of heat, by natural cooling, from the outer surface of the reactor pressure vessel 6 in a state in which the heat insulation 4 is broken is performed for Fukushima Unit 1. The important fact here is that values measured in the state of all power loss are only four values; i.e., 0.6 MPa (two values), 0.84 MPa, and 400° C. and that the results of the above-described calculation coincide with these four values without any inconsistency.

Also, the fact that the dose rate (measured) near the main gate of the power plant remained at a very low level and did not change during this period and in three days or more after that coincides well with the following thought, which is the premise of the present calculation. Namely, penetration (melt-through) of the bottom of the reactor pressure vessel did not occur, and radioactive substances generated in the reactor pressure vessel 3 flowed into the water inside the S/C 15, passing through the safety valve (SRV). The residual radioactive substances after being purified (removed mostly) by the water, leaked from the top lid 6a of the D/W 14. (This top lid 6a, in actuality, forms a top lid of the reactor containment vessel 6.)

### (Actions and Effects of the Invention of Claim 2)

Next, the actions and effects of the invention of claim 2 will be described.

The invention of claim 2 includes not only the means (1)(i.e., means (a) and (b)) of the invention of claim 1 but also means for preventing breakage of the reactor containment vessel, thereby maintaining the soundness of the reactor containment vessel, and preventing release of radioactive substances to the outside, when the internal pressure of the reactor containment vessel increases at the time of a core meltdown accident, irrespective of whether or not water injection into the core is continued or stopped.

The reason why the invention of claim 2 includes such a means is that this invention expects, in particular, a core meltdown accident in a PWR.

As described above, this means includes the following means (2) and (3).
(2) A large-diameter through hole provided at a pressure boundary of a reactor containment vessel and a rupture plate provided in the through hole.
(3) Means for submerging the through hole of the above-described means (2) in water during ordinary operation of the reactor.

Their actions and effects are as follows.

Notably, since the actions and effects of the means (1) of the invention of claim 2 are the same as those of the invention of claim 1, their repeated descriptions are omitted.

At the time of a core meltdown accident, heat is generated in the core as a result of decay of fuel and as a result of the zirconium-water reaction, and hydrogen and steam flow to the reactor containment vessel, thereby increasing the internal pressure of the containment vessel.

In particular, in the case where water injection into the core is continued by using a fire pump or the like after the core has entered a film boiling state, in proportion to the pressure increase, the zirconium-water reaction progresses and the amount of generated hydrogen gas also increases. Therefore, the containment vessel pressure increases acceleratingly. In order to suppress such a sharp increase in pressure, it is necessary to form a large-diameter through hole at the pressure boundary of the containment vessel and dispose a rupture plate (rupture disk) in the through hole. Also, it is necessary to form the rupture plate to have an appropriate large diameter so that breakage of the rupture plate reduces the pressure quickly, thereby stopping the accelerating pressure increase, and further reduces the pressure (the means (2) of claim 2).

A containment vessel vent valve having a diameter of about 20 to 30 cm at the TEPCO Fukushima accident was insufficient. A rupture plate having a large diameter (about 50 cm to 1 m) like the pressure boundary penetration portion for the fuel transportation pipe is necessary. This can be confirmed by conventional pressure analysis of the containment vessel.

Also, in the case where water injection into the core is continued at the time of an accident in which the core does not melt (film boiling does not occur) and in which reactor cooling water jets to the interior of the containment vessel, the pressure of the reactor containment vessel increases due to the decay heat alone and may exceed the designed pressure after elapse of a certain time, if a containment vessel spray facility or a core cooling facility does not operate. At that time, the rupture plate becomes necessary for protecting the containment vessel. However, since the diameter of the rupture plate necessary in this case is small, the above-described large-diameter rupture plate provides the function of this rupture plate.

In either case, when the rupture plate is broken, radioactive substances are released from the core to the outside. In order to purify or remove the radioactive substances with water at a release port or a route therefor (including the large-diameter through hole formed at the pressure boundary of the reactor containment vessel), a region around them is submerged in water (the means (3) of claim 2).

By virtue of this, a new pressure releasing (pressure reducing) means (the means (2) of claim 2) is obtained, and a new radioactive substance purifying or removing means (the means (3) of claim 2) is obtained. Thus, even after elapse of 10 to 14 hours from occurrence of the accident, it is possible to stop the accelerating increase in the containment vessel pressure, thereby keeping the soundness of the reactor containment vessel without fail, and to prevent release of radioactive substances, such as volatile FP whose radioactivity level is high, to the outside.

### Effects of the Inventions

As is apparent from the above descriptions of the actions and effects of the inventions of claims 1 and 2, the present invention can keep the soundness of the reactor pressure vessel, keep the soundness of the reactor containment vessel (which is the last resort of protection), and prevent release of radioactive substances to the outside, even in an accident (severe accident) which is extremely rare but is the severest; i.e., a core meltdown accident in a state of all power loss, such as that observed in the TEPCO Fukushima accident.

Namely, in the case of a small reactor (whose size is the same as or smaller than the size of Fukushima Unit 1), removal of the decay heat after stoppage of the reactor (stoppage of nuclear fission reaction) is performed by natural cooling. Specifically, when the water injection into the core by a fire pump or the like is stopped and the reactor is left as it is, the heat insulation breaks due to an increase in the temperature of the wall of the reactor pressure vessel, and, as a result of natural convection of gas around the reactor, the reactor is naturally cooled through the outer surface of the pressure vessel.

Also, in the case of a large reactor, the decay heat is removed by water cooling. Specifically, since natural cooling of the outer surface of the reactor pressure vessel is insufficient, the water injection means for injecting water to the space inside the shield concrete (between the heat insulation of the reactor pressure vessel and the shield concrete) after stoppage of water injection into the core is provided so as to perform cooling of the outer surface of the pressure vessel or the outer surface of its heat insulation by evaporation heat of water. Thus, the reactor is water-cooled through the outer surface of the pressure vessel or the outer surface of its heat insulation.

By virtue of these, it is possible to obtain an extremely safe reactor capable of coping with a core meltdown accident, which can keep the soundness of the reactor pressure vessel and the reactor containment vessel and prevent (minimize) release of radioactive substances to the outside, thereby keeping its function, even at the time of the core meltdown accident.

Notably, since necessary modifications, design changes, operational changes, etc. are limited, a considerably effective results can be obtained by slightly changing the light water reactor currently used.

### BRIEF DESCRIPTION OF THE DRAWINGS

FIG. 1 is a vertical sectional view of a shell portion (including a pressure vessel wall, a heat insulation, and a gap) of a pressure vessel of a reactor (BWR, PWR) of a first embodiment of the present invention.

FIG. 2 is a schematic view of a vertical cross section of a reactor (PWR) of a second embodiment of the present invention, the schematic view being obtained by seeing a pressure boundary portion of the containment vessel in a horizontal direction and being used for describing a large-diameter through hole formed in the pressure boundary portion and a means for submerging the through hole in water.

FIG. 3 is a vertical sectional view of a building and a containment vessel portion of a conventional reactor (BWR), the vertical sectional view being used for describing analysis of data which was collected from Fukushima Unit 1 at the time of breakage of the heat insulation of its reactor pressure vessel.

FIG. 4 is a partial enlarged view of FIG. 3.

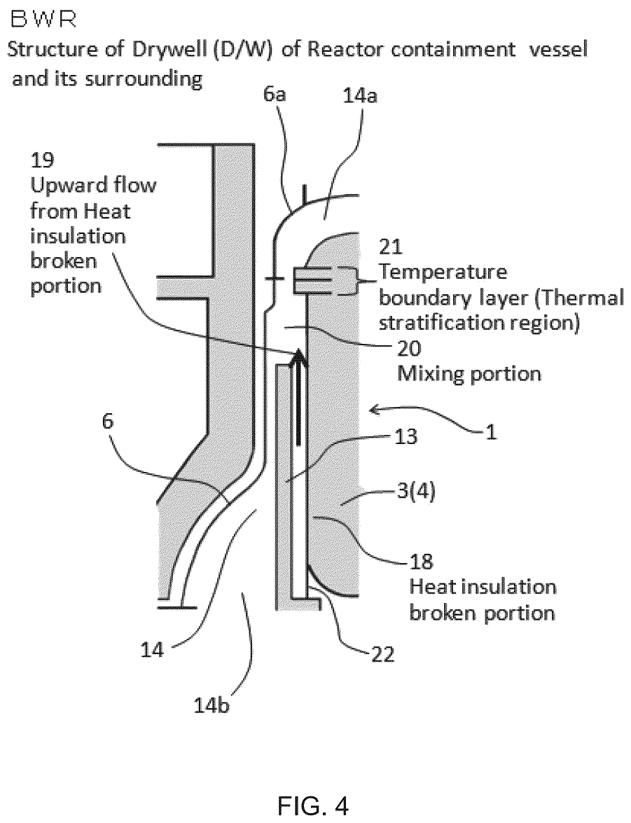

### DETAILED DESCRIPTION OF THE INVENTION

### First Embodiment

Next, a first embodiment of a reactor of the present invention which can cope with a core meltdown accident with an aim of preventing release of radioactive substances will be described with reference to the drawings.

This first embodiment is a reactor in which the invention of claim 1 is implemented and which is preferably used in a boiling water reactor (BWR).

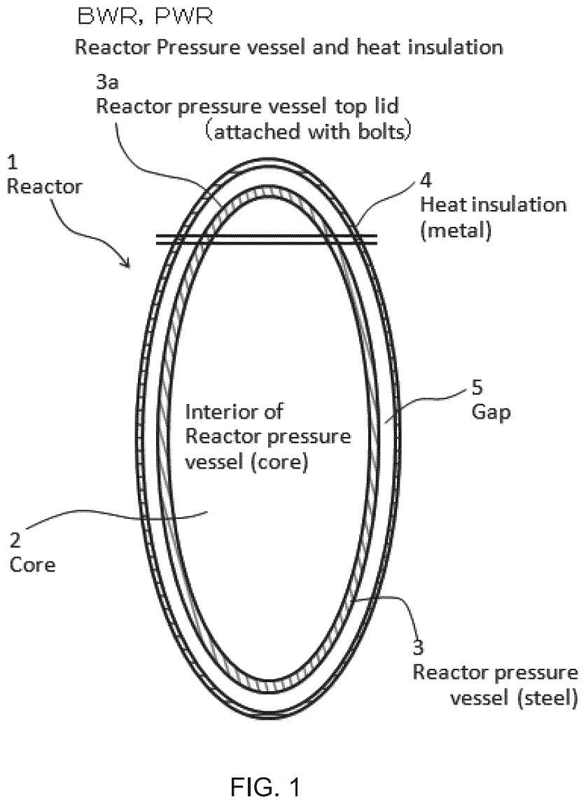

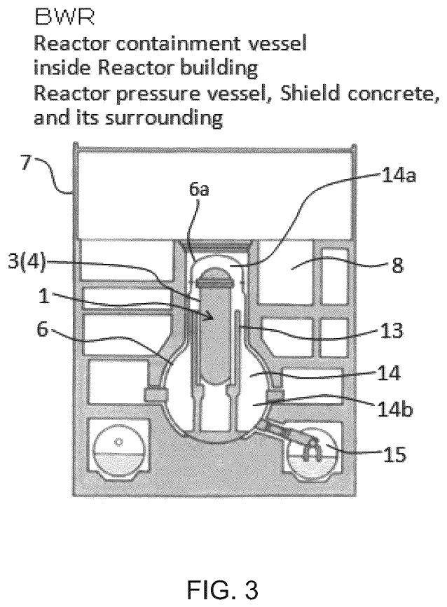

As shown in FIGS. 1 and 3, the reactor of the first embodiment includes the following means (1); i.e., means (a) and (b).
(1)(a) Water-injection-to-core interruption means, provided for a possible core meltdown accident, for stopping injection of water into a core 2 after occurrence of a zirconium-water reaction or film boiling in the core 2 is detected on the basis of core pressure or the like.
(b) Means for naturally cooling or water-cooling the outer surface of the reactor pressure vessel 3 or the outer surface of the heat insulation 4, whereby, when a core meltdown accident occurs, after injection of water into the core 2 is stopped by the water-injection-to-core interruption means (a), core decay heat is removed not only by radiation of radiant heat from an outer surface of the reactor pressure vessel 3 but also removed as a result of natural cooling or water cooling of the outer surface of the reactor pressure vessel 3 or the outer surface of the heat insulation 4.

In the case (i) where the reactor 1 is small in size, the means for natural cooling or water cooling of above (b) is melting point restriction management means for the heat insulation 4 which manages a melting point restriction in material selection at the time of manufacture of the heat insulation 4 so that the heat insulation 4 melts and breaks without fail at the time of the core meltdown accident, whereby the core decay heat is removed also by natural cooling of the outer surface of the reactor pressure vessel 3.

In the case (ii) where the reactor 1 is large in size, the means for natural cooling or water cooling of above (b) is water injection means for injecting water into a space between the heat insulation 4 of the reactor pressure vessel 3 and a shield concrete 13, whereby the core decay heat is removed also by water cooling of the outer surface of the reactor pressure vessel 3 or the outer surface of the heat insulation 4.

Embodiments of these means will now be described more specifically.

First, an embodiment of the means (1)(a) will be described. A pressure gauge currently used for coping with accidents can be used as the means for detecting core pressure.

Even in the case where use of measurement devices or the like is impossible because of, for example, all power loss, the timing of transition to film boiling can be predicted to some extent on the basis of a time elapsed after loss of core cooling, a decrease in the amount of held water, decay heat, etc. Therefore, after that timing, the injection of water into the core 2 of the reactor 1 is stopped, and the outer surface of the pressure vessel 3 is naturally cooled as a result of natural convection of gas around the reactor pressure vessel 3; i.e., the reactor 1 starts to operate as a natural cooling reactor. Notably, this natural convection of gas is caused by the means (1)(b) (for the case (i)) described next; namely, this natural convection of gas occurs as a result of the heat insulation 4 melting and breaking due to an increase in the temperature of the pressure vessel 3.

Therefore, as to the means (1)(a), a large operational change or the like is unnecessary, as compared with the conventional reactor.

Next, an embodiment of the means (1)(b) (for the case (i)) will be described. Since the melting point restriction management means was actually achieved in the present Fukushima Unit 1, this means can be used continuously.

Specifically, aluminum metal is used for the material of the heat insulation, and its melting point is about 650° C. It is considered that, when the injection of water into the core 2 is stopped at the time of the core meltdown accident, a high temperature portion of the reactor pressure vessel 3 near the melted core 2 increased to about 650° C. due to heat generated as a result of decay of the fuel. Therefore, it is considered that the heat insulation 4 melted and broke. It is considered that, as a result, natural convection of gas (steam and nitrogen gas) occurred around the reactor 1, and the reactor 1 was naturally cooled through the outer surface of its pressure vessel.

Meanwhile, the strength of the reactor pressure vessel 3 (which is formed of low alloy steel) is maintained even when its temperature increases to about 650° C.

Next, an embodiment of the means (1)(b) (for the case (ii)) will be described. The water injection means merely injects water from an upper portion of the shield concrete 13 inside the containment vessel 6 into a space inside the shield concrete 13. However, it is necessary to newly install a pipe.

In the case of a large reactor 1 which generates large output power, mere natural cooling of the outer surface of the reactor pressure vessel 3 is insufficient for cooling the reactor pressure vessel 3. Therefore, by the water injection means, water is injected into the space inside the shield concrete 13 (into the space between the heat insulation 4 of the reactor pressure vessel 3 and the shield concrete 13), whereby the outer surface of the reactor pressure vessel 3 or the outer surface of the heat insulation 4 is cooled by evaporation heat of the water.

### Second Embodiment

Next, a second embodiment of the reactor of the present invention which can cope with a core meltdown accident with an aim of preventing release of radioactive substances will be described with reference to the drawings.

This second embodiment is a reactor in which the invention of claim 2 is implemented and which is preferably used in a pressurized water reactor (PWR).

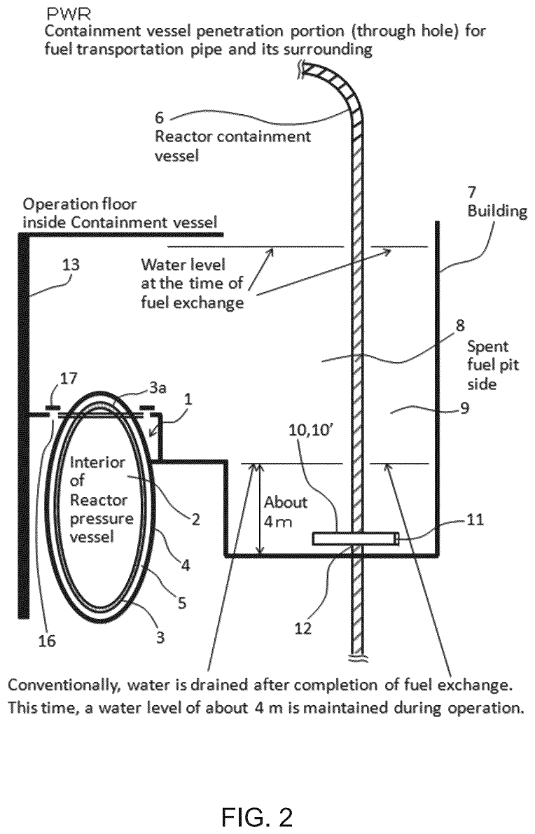

The reactor of the second embodiment includes not only the means (1)(i.e., means (a) and (b)), which are provided in the reactor of the first embodiment, but also the following means (2) and (3) as shown in FIGS. 1 and 2.
(2) A large-diameter through hole 10 formed at the pressure boundary of the reactor containment vessel 6, and a rupture plate 11 provided in the through hole 10.
(3) Means for submerging the through hole 10 of the above-described means (2) in water during ordinary operation of the reactor 1.

The reasons why the reactor of the second embodiment includes not only the means (1)(i.e., the means (a) and (b)) but also the means (2) and (3) is that the reactor of this embodiment is designed in consideration of a core meltdown accident in the PWR in particular, as described in the section of EFFECTS OF THE INVENTION.

In the PWR, at the time of a core meltdown accident, presumably, the pressure inside the reactor containment vessel 6 increases quickly irrespective of whether or not water injection into the core is continued or stopped. In order to cope with such a case, means for preventing breakage of the containment vessel 6, thereby maintaining the soundness thereof, and preventing release of radioactive substances to the outside is demanded. The means (2) and (3) are provided to meet the demand.

Embodiments of these means will now be described more specifically.

Since the embodiment of the means (1)(i.e., the means (a) and (b)) has already been described in the description of the first embodiment, they will not be described repeatedly. However, the following supplementary description will be provided for the means (1)(b) (for the case (ii)).

As to injection of water into the space inside the shield concrete 13 by the means (1)(b) (for the case (ii)) in the case where the reactor output is increased, the water injection is performed by newly installing a pipe in the case of the BWR as having been already described in the description of the first embodiment. However, in the case of the PWR, the following means can be employed instead of the water injection means.

Namely, as will be described later for the embodiments of the respective means (2) and (3), the through hole 10 formed at the pressure boundary of the reactor containment vessel 6 is fixedly provided in a depthwise region of about 4 m from the bottom of a cavity 8 within the containment vessel 6 such that the through hole 10 penetrates the wall of the containment vessel 6. At the time of ordinary operation of the reactor 1, a region around the through hole 10 is submerged in water. This is performed by supplying water to the same depthwise region within the cavity 8 by using the same water supply line used for filling the cavity 8 with water at the time of fuel exchange. Therefore, the water supply line used for filling the cavity 8 with water can be used as the means for submerging the region around the through hole 10 in water. Thus, it becomes possible to supply water for water cooling of the outer surface of the reactor pressure vessel 3 or the outer surface of the heat insulation 4 thereof.

Specifically, in this case, water is supplied from this water supply line such that the water level within the cavity 8 exceeds the level of the depthwise region of about 4 m from the bottom of the cavity 8 and reaches the level of a reactor pressure vessel top lid 3a (hereinafter referred to as the “top lid 3a” in some cases). When water is supplied in this manner, water can be supplied naturally to the space inside the shield concrete 13.

This point will be described in more detail. As shown in FIGS. 1 and 2, an upper portion of the reactor pressure vessel 3 is formed by the above-described reactor pressure vessel top lid 3a, and this top lid 3a is fixed to the main body of the reactor pressure vessel 3 with bolts. A ring-shaped protrusion is welded to a lower portion of the top lid 3a, and a gap (cavity seal portion) 16 having a predetermined size is formed between this protrusion and the shield concrete 13. This gap 16 is covered with a manually movable ring, which will be referred to as the “cavity seal ring 17.” The gap 16 can be closed and opened by moving this cavity seal ring 17 upward and downward.

During the ordinary operation, the gap 16 is opened by an amount of several centimeters, so that air for cooling the outer surface of the heat insulation 4 flows from the lower side of the reactor pressure vessel 3 into the cavity 8 through this gap 16 of the seal portion. At the time of fuel exchange, this gap 16 is closed (the ring 17 is moved downward), and the cavity 8 is completely filled with water for fuel exchange. At the time of a core meltdown accident, since the gap 16 remains open (the state during the ordinary operation). Therefore, when water is supplied from the water supply line, the water level in the depthwise region of about 4 m from the bottom of the cavity 8 ascends and water naturally flows downward from the gap 16 of the seal portion along the outer surface of the heat insulation 4 inside the shield concrete 13.

Next, an embodiment of the means (2) will be described. In the conventional PWR, a fuel transportation pipe 10′ (having rails laid therein) is disposed in a penetration portion for fuel transportation 12 at the pressure boundary of the reactor containment vessel 6. This fuel transportation pipe 10′ is used, as it is, as the large-diameter through hole 10 formed at the pressure boundary of the containment vessel 6, and a lid used for closing the fuel transportation pipe 10′ is replaced with a rupture plate (rupture disk) 11, which is designed to break by itself upon reception of a predetermined pressure. The rupture plate 11 is disposed in the through hole 10.

Conventionally, the above-described penetration portion for fuel transportation 12 is provided in the depthwise region of about 4 m from the bottom of the cavity 8 within the containment vessel 6, and the fuel transportation pipe 10′ is also fixedly provided in this region such that the fuel transportation pipe 10′ penetrates the wall of the containment vessel 6.

Therefore, the through hole 10 of the present second embodiment is also disposed in the same manner in the depthwise region of about 4 m from the bottom of the cavity 8.

As a result, the through hole 10 can function as a route for releasing over pressure within the containment vessel 6, thereby reducing the pressure, and can play the role of the conventional fuel transportation pipe 10′ in the same manner.

The rupture plate 11 can be disposed in an outer end portion of the through hole 10, which protrudes from the pressure boundary of the containment vessel 6 into a passage 9 outside the containment vessel 6. This passage 9 communicates with a spent fuel pit (not shown) provided in the building 7.

The breaking pressure of the rupture plate 11 is set freely; however, the breaking pressure of the rupture plate 11 is set to a designed pressure (maximum operating pressure) or higher so as to satisfy the current regulatory standards.

Therefore, the means (2) can also be implemented easily by remodeling the conventional facility and changing the operation, which are easy.

Here, the outline of the operation of fuel exchange performed through the conventional fuel transportation pipe 10′ will be described briefly. This clarifies the role of the through hole 10 of the present second embodiment.

In the case of the conventional PWR, at the time of fuel exchange, water is first supplied into the cavity 8 and the passage 9 until the water level nearly reaches an operation floor within the containment vessel 6 as shown in FIG. 2.

Next, fuel assemblies within the reactor pressure vessel 3 are taken out one at a time by using a crane. The taken out fuel assembly is temporarily placed on an upper floor surface located at a height of about 4 m or more from the bottom of the cavity 8. Subsequently, the fuel assembly is transported downward to the bottom floor surface of the cavity 8. The fuel assembly is laid down there and is stored in the fuel transportation pipe 10′. Subsequently, by a remote operation, the fuel assembly is passed through the fuel transportation pipe 10′ to the passage 9 on the spent fuel pit side. The fuel assembly is raised vertically there, and the raised fuel assembly is transported from the passage 9 to the spent fuel pit.

When a new fuel assembly is transported, the new fuel assembly is transported from the passage 9 into the reactor pressure vessel 3 by the operations performed in the order reverse to the order of the above-described operations.

These transportation works are all performed on the operation floor by remotely operating the crane, and all the fuel assemblies are manipulated within water.

After the fuel exchange is completed in this manner, water is drained from the cavity 8 and the passage 9, and a lid is attached to the fuel transportation pipe 10′. These are conventional operations.

The through hole 10 of the present second embodiment can also play the role of the conventional fuel transportation pipe 10′ in the same manner as described above.

Next, an embodiment of the means (3) will be described. Since the embodiment differs from the conventional practice only in the operation of filling the cavity 8 within the containment vessel 6 with water and the operation of filling the passage 9, which communicates with the containment vessel 6 through the through hole 10, with water, the embodiment of this means can be realized by additionally providing a water level gauge for continuous monitoring.

Therefore, the means (3) can be implemented easily without necessity of large-scale remodeling of the facility, a great change in operation, etc. as compared with the conventional reactor.

The operation of filling the cavity 8 within the containment vessel 6 with water will be described specifically. During an ordinary operation after fuel exchange, water is kept to fill a deepened portion of the cavity 8; i.e., the depthwise region of about 4 m from the bottom of the cavity 8. At the same time, water is supplied to the passage 9 such that the water level in the passage 9 becomes the same as the water level in the cavity 8.

By supplying water in this manner, the through hole 10 provided in the same depthwise region within the cavity 8 can be easily submerged in water at the time of ordinary operation of the reactor 1.

Conventionally, the depthwise region of about 4 m from the bottom of the cavity 8 and the region within the passage 9 having the same depth are submerged in water at the time of fuel exchange. When the ordinary operation of the reactor 1 is performed after completion of fuel exchange, water is drained from these regions and these regions become empty. Since purifying action by water is very effective for fission products (FPs) whose radioactivity levels are high, such as volatile FP, the operation as described above is very effective for preventing release of radioactive substances.

Although embodiments of the present invention have been described, the present invention is not limited to the above-described embodiments, and various modifications can be made without departing from the gist of the present invention.

For example, in the embodiments of the present invention, the cladding tube of fuel stored in the core is a zirconium tube. However, the cladding tube is not limited thereto and may be a cladding tube formed of a metallic material which generates reaction heat by reacting with water at high temperature. The present invention can be applied to a reactor in which fuel rods covered with cladding pipes formed of such a material are stored in the core.

As described above, the present inventor has achieved the invention by analyzing the cause of the TEPCO Fukushima accident by strictly following actual measurements, and checking, one by one, the measurement results and progresses of events, while ascertaining their physical phenomena. For that, analysis and evaluation of the boiling phenomenon at the time of the zirconium-water reaction, in particularly, on the basis of the theory of boiling heat transfer, was important.

Since the process of analyzing its cause, which was the basis of the present invention, are summarized in papers, the inventor submits these papers, as Material 1 and Material 2, for reference.

Material 1, Tsuyoshi Matsuoka, “Analysis of Status Fourteen Hours after All Power Loss at the Fukushima Daiichi Nuclear Power Plant Unit 1,” Japanese journal of Atomic Energy Society of Japan, Vol. 21, No. 1 (scheduled to be published on Mar. 1, 2022), published by Atomic Energy Society of Japan

Material 2, Tsuyoshi Matsuoka, “New approach for describing reactor and containment pressure change after loss of core cooling at Fukushima meltdown accident,” Japanese journal of Atomic Energy Society of Japan, Vol. 20, p 131-142 (scheduled to be published in September, 2021), published by Atomic Energy Society of Japan

### DESCRIPTION OF REFERENCE NUMERALS

1: reactor, 2: core, 3: reactor pressure vessel, 3a: reactor pressure vessel top lid, 4: heat insulation, 5: gap, 6: reactor containment vessel, 6a: reactor containment vessel top lid (drywell (D/W) top lid), 7: building, 8: cavity, 9: spent fuel pit side passage, 10: through hole, 10′: fuel transportation pipe (conventional), 11: rupture plate (rupture disk), 12: penetration portion for fuel transportation, 13: shield concrete (shield wall), 14: drywell (D/W), 14a: drywell (D/W) upper portion, 14b: drywell (D/W) lower portion (including the mixing region), 15: pressure suppression chamber (S/C), 16: gap (cavity seal portion), 17: cavity seal ring, 18: heat insulation broken portion, 19: upward flow of superheated steam, 20: mixing region, 21: temperature boundary layer (thermal stratification region), 22: reactor pressure vessel skirt portion.

What is claimed is:

1. A reactor which can cope with a core meltdown accident with an aim of preventing release of radioactive substances, the reactor being characterized by comprising the following means (1) whereby, at the time of a possible core meltdown accident, the reactor is naturally cooled or water-cooled through an outer surface of a reactor pressure vessel or an outer surface of its heat insulation and release of radioactive substances is prevented:
(1)(a) water-injection-to-core interruption means, provided for a possible core meltdown accident, for stopping injection of water into a core after occurrence of a zirconium-water reaction or film boiling in the core is detected on the basis of core pressure or the like, and
(b) means for naturally cooling or water-cooling the outer surface of the reactor pressure vessel or the outer surface of the heat insulation, whereby, when a core meltdown accident occurs, after injection of water into the core is stopped by the water-injection-to-core interruption means (a), core decay heat is removed not only by radiation of radiant heat from the outer surface of the reactor pressure vessel but also removed as a result of natural cooling or water cooling of the outer surface of the reactor pressure vessel or the outer surface of the heat insulation, wherein
in the case (i) where the reactor is small in size, the means for natural cooling or water cooling is melting point restriction management means for the heat insulation which manages a melting point restriction in material selection at the time of manufacture of the heat insulation so that the heat insulation melts and breaks without fail at the time of the core meltdown accident, whereby the core decay heat is removed also by natural cooling of the outer surface of the reactor pressure vessel, and
in the case (ii) where the reactor is large in size, the means for natural cooling or water cooling is water injection means for injecting water into a space between the heat insulation of the reactor pressure vessel and a shield concrete, whereby the core decay heat is removed also by water cooling of the outer surface of the reactor pressure vessel or the outer surface of the heat insulation.

2. A reactor which can cope with a core meltdown accident with an aim of preventing release of radioactive substances, the reactor being characterized by comprising the following means (1) to (3) whereby, at the time of a possible core meltdown accident, the reactor is naturally cooled or water-cooled through an outer surface of a reactor pressure vessel or an outer surface of its heat insulation and release of radioactive substances is prevented:
(1)(a) water-injection-to-core interruption means, provided for a possible core meltdown accident, for stopping injection of water into a core after occurrence of a zirconium-water reaction or film boiling in the core is detected on the basis of core pressure or the like, and
(b) means for naturally cooling or water-cooling the outer surface of the reactor pressure vessel or the outer surface of the heat insulation, whereby, when a core meltdown accident occurs, after injection of water into the core is stopped by the water-injection-to-core interruption means (a), core decay heat is removed not only by radiation of radiant heat from the outer surface of the reactor pressure vessel but also removed as a result of natural cooling or water cooling of the outer surface of the reactor pressure vessel or the outer surface of the heat insulation, wherein
in the case (i) where the reactor is small in size, the means for natural cooling or water cooling is melting point restriction management means for the heat insulation which manages a melting point restriction in material selection at the time of manufacture of the heat insulation so that the heat insulation melts and breaks without fail at the time of the core meltdown accident, whereby the core decay heat is removed also by natural cooling of the outer surface of the reactor pressure vessel, and
in the case (ii) where the reactor is large in size, the means for natural cooling or water cooling is water injection means for injecting water into a space between the heat insulation of the reactor pressure vessel and a shield concrete, whereby the core decay heat is removed also by water cooling of the outer surface of the reactor pressure vessel or the outer surface of the heat insulation;
(2) a large-diameter through hole provided at a pressure boundary of a reactor containment vessel and a rupture plate provided in the through hole; and
(3) means for submerging the through hole of the means (2) in water during ordinary operation of the reactor.
